(19) United States
(12) Patent Application Publication
(10) Pub. No.: US 2003/0020958 A1
(43) Pub. Date: Jan. 30, 2003

(54) Non-polarizing shutter/CCD module

(76) Inventors: Heather Noel Bean, Fort Collins, CO (US); Mark Nelson Robins, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/917,961

(22) Filed: Jul. 30, 2001

(51) Int. Cl. H04N 1/21; H04N 1/23

(52) U.S. Cl. 358/302

(57) ABSTRACT

An imaging module and light shuttering method for a digital image capturing device. The imaging module includes an electronic imaging sensor device including a plurality of pixel elements. The imaging module further includes an electronically actuatable shutter device including a plurality of individually addressable and actuatable shutter elements. Each shutter element substantially corresponds to at least one of the plurality of pixel elements of the image sensor device.

### FIELD OF THE INVENTION

The present invention relates generally to an electronic shutter and imaging sensor device combination, and more particularly to an electronic shutter and imaging sensor device combination that allows a pixel-by-pixel shuttering operation to be performed.

### BACKGROUND OF THE INVENTION

Still image capturing devices are used to visually memorialize scenes, events, or items. Still image capturing devices, such as digital cameras, include a lens, a shutter, and an electronic image sensor device. In addition, most modern cameras include a processor and/or other control electronics that function to control shutter speed, aperture, flash, focus, etc.

The shutter and the electronic (digital) sensor device are the main components of a still image capturing device and operate together in order to produce a digital image. In operation, the shutter is opened briefly to expose the electronic sensor device and thereby form an image. The operation of the shutter is very important and the quality of the captured image depends on a proper exposure time based on lighting, movement of the subject, focus distance, etc.

A prior art shutter approach used a mechanical shutter. The mechanical shutter has been widely used for a number of years and is generally in the form of an iris-type shutter. However, the prior art mechanical shutter has many drawbacks, including weight, large size, susceptibility to dirt, wear and tear, and the difficulty of precisely controlling shutter exposure times over a wide range of conditions. In addition, the typical iris-type mechanical shutter exposes the center of the image for a longer time than the edges of the image because of the iris-like movement.

In some prior art cameras, the mechanical shutter is electronically activated by a motor or other electrical actuator. This may produce a more accurate shutter control, but consumes a lot of electrical energy, is inflexible, and still exposes the image unevenly.

One approach to these drawbacks has been to use an electronic shutter, such as a liquid crystal display (LCD) element. This gives a prior art camera a precise electronic control over exposure times, and eliminates moving parts. In addition, the LCD element may be switched to a light transparent state over all regions of the LCD element at once, unlike a mechanical iris-type shutter. This produces an even exposure time over the entire image area. In addition, an electronic LCD shutter can be set to varying levels of opacity in order to reduce the brightness of very bright scenes.

However, the prior art electronic LCD shutter has several drawbacks. Because an LCD device polarizes the light that passes through it, a prior art LCD shutter captures an image using polarized light. This may produce light irregularities if the light source used to capture the image is polarized, since only light polarized in a single plane passes through the shutter. In addition, the dual polarizing films used in prior art LCD shutters significantly reduce the amount of light that reaches the film or electronic imaging element.

Therefore, there remains a need in the art for improvements in still image capturing devices.

### SUMMARY OF THE INVENTION

An imaging module for a digital image capturing device includes an electronic imaging sensor device comprising a plurality of pixel elements. The imaging module further comprises an electronically actuatable shutter device comprising a plurality of individually addressable and actuatable shutter elements. Each shutter element substantially corresponds to at least one of the plurality of pixel elements.

### BRIEF DESCRIPTION OF THE DRAWINGS

FIG. 1 is a block diagram of a still image capturing device according to one embodiment of the invention;

FIG. 2 shows detail of an imaging module according to one embodiment of the invention;

FIG. 3 is a flowchart of a light shuttering method for a still image capturing device according to another embodiment of the invention; and

FIG. 4 is a flowchart of a light shuttering method according to yet another embodiment of the invention.

### DETAILED DESCRIPTION

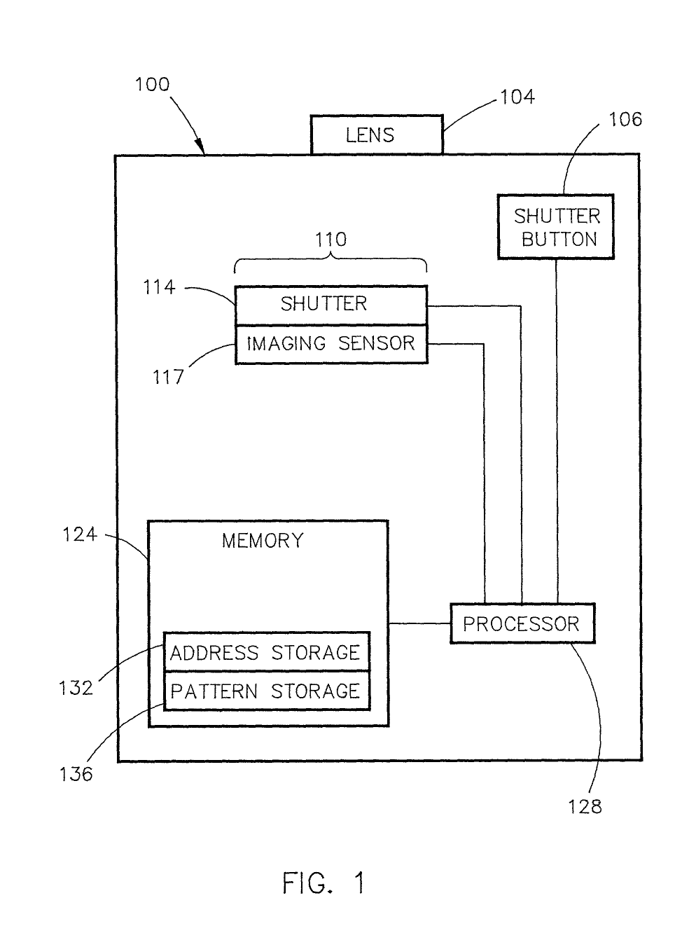

FIG. 1 is a block diagram of a still image capturing device 100 according to one embodiment of the invention. The still image capturing device 100 includes a lens apparatus 104, a shutter button 106, a processor 128, a memory 124, and an imaging module 110.

The processor 128 may be any type of general purpose processor and may control the overall operation of the still image capturing device 100. The processor 128 receives inputs from the shutter button 106 and controls a shuttering operation of the imaging module 110 in order to capture an image. In addition, the processor 128 controls the storage of digital images produced by the imaging sensor device 117. For example, the processor 128 may receive images and store them in the memory 124. In addition, the processor 128 receives user inputs and performs functions specified by user inputs.

The imaging module 110 receives light from the lens apparatus 104 and is capable of capturing an image that is focused onto the imaging module 110. The imaging module 110 includes an integrated shutter device 114 and imaging sensor device 117. The imaging sensor device 117 comprises a two-dimensional array of pixel elements. The electronic imaging sensor device 117 may be a CCD sensor array or a CMOS sensor array, for example.

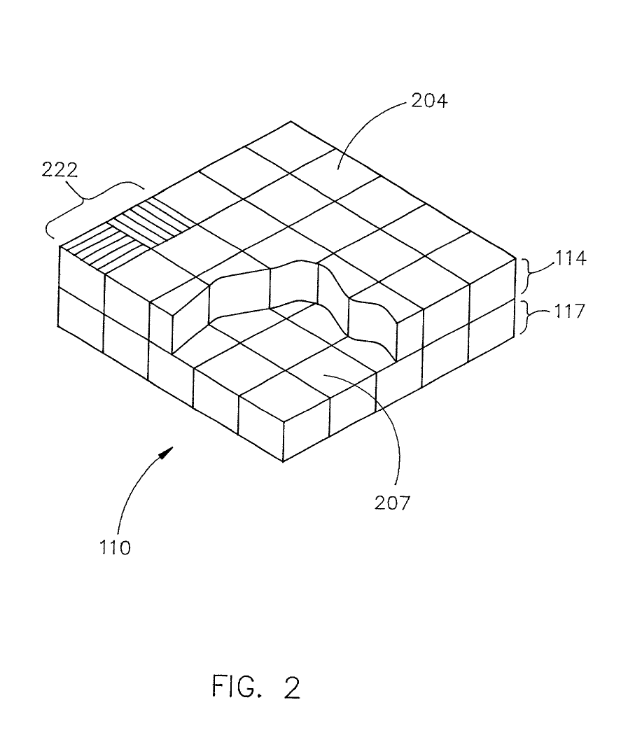

The shutter device 114 is electronically actuated and comprises a two dimensional array of individually addressable shutter elements (see FIG. 2 and accompanying discussion). The shutter device 114 is preferably a liquid crystal display (LCD) element comprising a two-dimensional array of individually addressable and actuatable shutter elements. Alternatively, the shutter device 114 may be a reflective microelectromechanical device comprising a two-dimensional array of electrically addressable and actuatable mechanical shutter elements.

In operation, the shutter device 114 is controlled by the processor 128 in response to a press of the shutter button 106. Incoming light enters the still image capturing device 100 through the lens apparatus 104 and impinges upon shutter device 114. When activated by the processor 128, the shutter device 114 allows the incoming light to pass through, i.e., the shutter device 114 transforms from a light opaque state to a light transmissive state. The shutter device 114 is controlled to be light-transmissive for a predetermined exposure period, and is controlled to become light-opaque at the end of the predetermined exposure period. Therefore, when the light passes through the shutter device 114 and impinges on the imaging sensor device 117, an image may be captured by the imaging sensor device 117.

The memory 124 may be any type of memory, including all types of random access memory (RAM), read-only memory (ROM), flash memory, magnetic storage media such as magnetic disc, tape, etc., or optical or bubble memory. The memory 124 may include, among other things, an address storage 132 that may store addresses of shutter elements or shutter pairs. In addition, the memory 124 may include a pattern storage 136 that may store one or more exposure patterns. In addition, the memory 124 may store software or firmware to be executed by the processor 128.

The one or more exposure patterns of the pattern storage 136 may be default values programmed at the factory or may be custom patterns input by the user. The user may select between patterns. In addition, a pattern may specify varying exposure time periods for individual shutter elements. Therefore, an image may be captured by specifying particular pixels to be exposed, but the user also may control exposure time lengths and may expose individual pixel elements or groups of pixel elements over different exposure time periods. Furthermore, in digital still cameras employing color filters for capturing color images as red, green, and blue pixels, each color may be separately shuttered.

In an embodiment where the shutter 114 may be placed in states of partial opacity, the shutter 114 may be controlled to be partially opaque. As a result, the shutter 114 may act as a filter, reducing the light intensity at the imaging sensor 117. This may include controlling the opacity of individual shutter elements 204 or of groupings of shutter elements. This may be advantageous when a scene or a portion of a scene is very bright.

FIG. 2 shows detail of the shutter 114 and an electronic image sensor 117. A two-dimensional array of shutter elements 204 is formed on or assembled to a two-dimensional array of image sensor pixel elements 207. Therefore, in one embodiment a shutter element 204 may correspond substantially in size to a pixel element 207. Alternatively, in another embodiment the shutter element 204 may correspond in size to two or more pixel elements 207, allowing a shutter element 204 to shutter two or more pixel elements 207. Furthermore, the shutter 114 is arranged so that the shutter elements 204 are substantially aligned with one or more corresponding pixel elements 207, and may operate to block or transmit light to the one or more corresponding pixel elements 207.

As previously discussed, the shutter 114 may comprise an LCD element formed of a two-dimensional array of individually addressable and actuatable shutter elements. Therefore, the processor 128 may actuate one or more shutter elements 204, may actuate a pattern of shutter elements 204, or may actuate shutter elements 204 for differing periods of time. The shutter elements 204 may be actuated in any combination, and may be actuated according to a pattern or timetable. Consequently, the imaging module 110 according to the invention is capable of performing a pixel-by-pixel shuttering. The invention may expose small regions, even individual pixel elements, because the shutter 114 may be formed on or assembled to the electronic image sensor 117. As a result, the shutter 114 may control exposure of the pixel elements 207 without any significant shuttering overlap, light leakage, loss of focus, etc.

In one embodiment, the LCD element is a polymer dispersed liquid crystal (PDLC) element that polarizes light but without requiring external polarizers. The PDLC element may be used regardless of the polarization effect, or alternatively a PDLC shutter 114 may be formed of shutter elements having different polarization orientations in order to pass substantially non-polarized light, as discussed below.

In another embodiment, the LCD element is a nematic or super-twisted nematic LCD. In these types of LCD, both the incoming and outgoing sides of the LCD element include a polarizer, such as a polarizing film. Therefore, the image capture employs polarized light. The polarizing single LCD element configuration is the simplest and cheapest and may be optimal due to the dark “off” state. The polarizing single LCD element configuration may therefore still be preferable even though it requires polarizers that reduce the light to the image sensor 117.

It may be possible to negate the polarizing effect, however. For example, a pixel unit 222 may comprise a pair of shutter elements 204 and a pair of pixel elements 207. The paired pixel element configuration of the pixel unit 222 is desirable because of the polarization. Therefore, a pixel unit 222 according to the invention may include a shutter element of a first polarization orientation and a shutter element of a second polarization orientation. The second polarization orientation is substantially orthogonal to the first polarization orientation. As a result, the two pixel element polarizations are combined to capture substantially non-polarized light, and therefore the imaging module 110 as a unit may capture a substantially non-polarized image.

The polarizer in this embodiment may be formed of narrow bands of polarizing film material, with each pixel element of a pixel unit 222 being located in a separate polarization band (the pixel elements may be separated by a small distance). The bands may be formed having substantially perpendicular polarization orientations. Alternatively, each shutter element 204 may have a corresponding polarizing element that is deposited on or otherwise formed on the LCD element.

The above non-polarizing shutter may alternatively be implemented using two LCD elements, a beam splitter, and a beam combiner. The beam splitter splits the incoming light into two light beams and each beam is separately directed into one of the two LCD shutters. In this embodiment, the two LCD shutters polarize the light, and the two LCD shutters are positioned in substantially perpendicular polarization orientations. The polarized light from each shutter is then directed into the beam combiner, wherein the two substantially perpendicularly polarized light beams are combined to form a substantially non-polarized resultant light beam.

In an alternate embodiment, the shutter 114 may comprise a two-dimensional array of individually addressable and actuatable reflective microelectromechanical shutter (MEMS) elements, as is known in the art. Unlike the prior art, however, the microelectromechanical elements are used as a reflective shutter, i.e., the MEMS device comprises actuatable mirror elements. The microelectromechanical elements may be actuated by an electric current to either direct light reflectively onto the imaging sensor 117 or scatter it to be absorbed by light-trapping material before coming into contact with the imaging sensor 117. As before, the actuation of the microelectromechanical elements is controlled by the processor 128 and may be controlled and actuated to selectively expose regions of the image sensor 117.

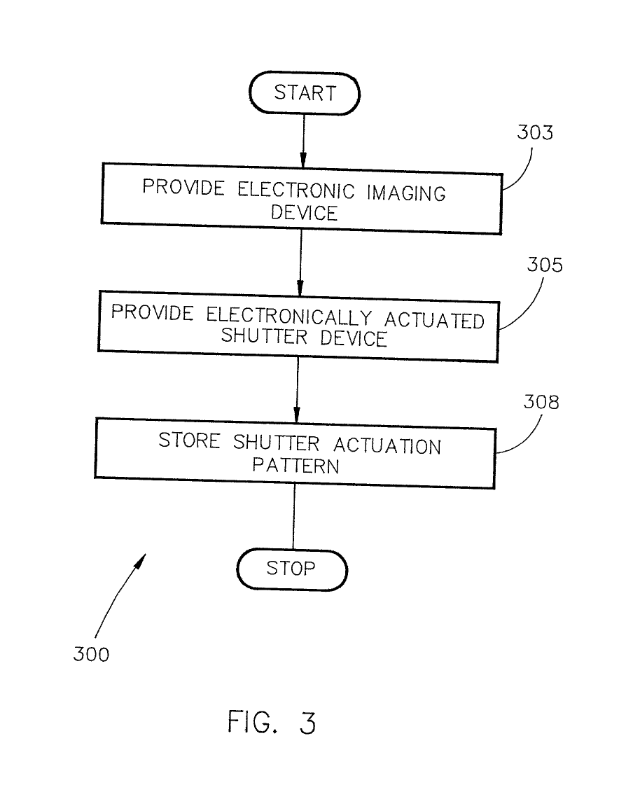

FIG. 3 is a flowchart 300 of a light shuttering method for a still image capturing device according to another embodiment of the invention. In step 303, an electronic imaging sensor device is provided. The imaging sensor device may be a two-dimensional array of pixel elements, and may be a CCD array or a CMOS array, for example.

In step 305, an electronically actuated shutter device is provided. The shutter device is preferably formed on or assembled with the imaging sensor device to form an imaging module. The shutter device is preferably a LCD element, but alternatively may be a microelectromechanical device having a plurality of individually actuatable mechanical shutters that may be electronically or magnetically actuated.

In optional step 308, one or more shutter actuation patterns may be stored. A shutter actuation pattern may be recalled and used to control actuation of one or more shutter elements. In this manner, individual pixel elements may be exposed as desired by the user. In addition, the pixel elements of the imaging sensor device 117 may be exposed for differing periods of time.

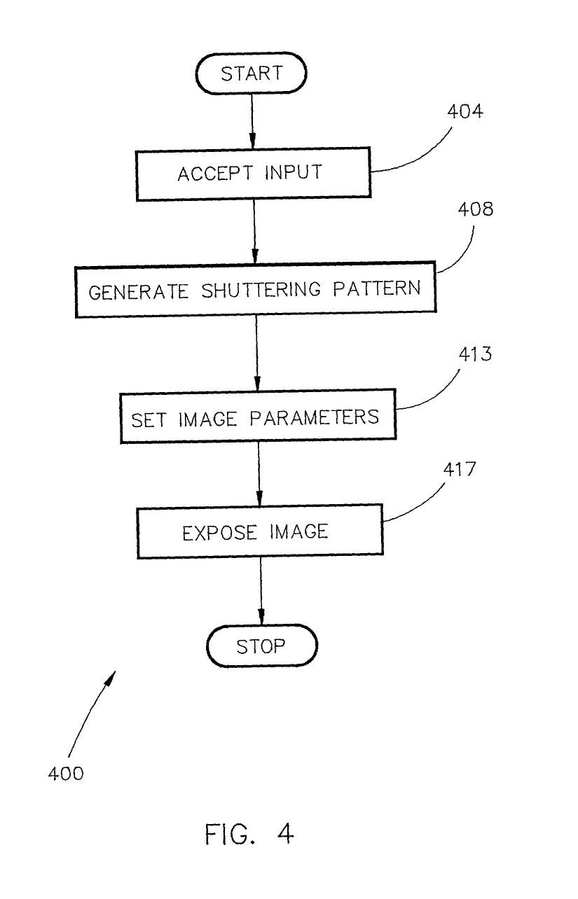

FIG. 4 is a flowchart 400 of a light shuttering method according to yet another embodiment of the invention. In step 404, a user input is accepted, with the user input specifying mode variables for an image capture. The user input may select mode variables such as light level, exposure times, exposure patterns, focus, etc.

In step 408, a shuttering pattern is generated in preparation for an image capture. The shuttering pattern may be automatically generated by the image capturing device 100, or alternatively may be generated by the user. The shuttering pattern is generated according to the current mode variables, along with measurements such as a focus depth, an ambient light level, etc.

In step 413, the image capture parameters may be set by the image capturing device 100, by the user, or both. The image parameters may include shutter speed, focus, flash, etc.

In step 417, an image is exposed using the previously generated shuttering pattern.

The various embodiments of the method and apparatus according to the invention may be applied to a digital still camera that includes a processor or circuitry to control the shutter device 114 and individual shutter elements 204. The invention differs from the prior art in that the user may control exposure regions and exposure time periods in the image capture. The user may expose regions of an image for varied exposure time periods. In addition, a LCD shutter may be employed that compensates for polarized light.

The invention provides several benefits. The invention provides an electronic control of exposure time periods, and therefore an increased accuracy and flexibility of exposure times. In addition, the invention may allow uniform exposure, wherein the center of the image is exposed for the same time period as the edges of image. The invention also provides an improved ruggedness, a lower power consumption than an electrically actuated mechanical shutter, and a greatly increased shuttering flexibility.

Complex exposure patterns and special effects are possible if pixels are selectively exposed. For example, different areas of an image could be exposed at different focus positions, thereby giving the appearance of good depth of field even with a large lens aperture. Different image areas could also be exposed for varying times, resulting in more shadow detail and an extended dynamic range that is greater than a dynamic range possible through use of just an imaging sensor device.

We claim:

1. An imaging module for a still digital image capturing device, comprising:
an electronic imaging sensor device comprising a plurality of pixel elements; and
an electronically actuatable shutter device comprising a plurality of individually addressable and actuatable shutter elements, each of said plurality of individually addressable shutter elements substantially corresponding to at least one of said plurality of pixel elements.

2. The apparatus of claim 1, wherein said imaging sensor device comprises a two-dimensional array of pixel elements and said shutter device comprises a LCD element comprising a two-dimensional array of individually addressable and actuatable shutter elements corresponding to said two-dimensional array of pixel elements.

3. The apparatus of claim 1, wherein said shutter device comprises a LCD element comprising a two-dimensional array of individually addressable and actuatable shutter elements and wherein a pixel unit of said imaging module comprises:
a first combination polarizing shutter element and pixel element, with said first polarizing shutter element being of a first polarization orientation; and
a second combination polarizing shutter element and pixel element, with said second polarizing shutter element being of a second polarization orientation that is substantially orthogonal to said first polarization orientation;
wherein said pixel unit is individually addressable and actuatable.

4. The apparatus of claim 1, wherein said shutter device comprises a microelectromechanical shutter element comprising a two-dimensional array of individually addressable and actuatable shutter elements.

5. The apparatus of claim 1, further comprising a memory including an address storage capable of storing one or more shutter element addresses.

6. The apparatus of claim 1, further comprising a memory including a pattern storage capable of storing one or more shuttering patterns that specify a plurality of shutter addresses of shutter elements to be actuated.

7. The apparatus of claim 1, further comprising a memory including a pattern storage capable of storing one or more shuttering patterns that specify a plurality of exposure time periods corresponding to a plurality of shutter elements to be actuated.

8. The apparatus of claim 1, wherein said shutter device is formed on and is substantially co-planar with said imaging sensor device.

9. The apparatus of claim 1, wherein said shutter device is assembled with and substantially co-planar with said imaging sensor device.

10. An imaging module for a still digital image capturing device, comprising:
an electronic imaging sensor device comprising a two-dimensional array of pixel elements; and
an electronically actuatable shutter device comprising a two-dimensional array of individually addressable and actuatable shutter elements formed on or assembled with and substantially co-planar with said imaging sensor device, each of said two-dimensional array of individually and actuatable addressable shutter elements substantially corresponding to at least one of said two-dimensional array of pixel elements.

11. The apparatus of claim 10, wherein said shutter device comprises a LCD element comprising a two-dimensional array of individually addressable and actuatable shutter elements and wherein a pixel unit of said imaging module comprises:
a first combination polarizing shutter element and pixel element, with said first polarizing shutter element being of a first polarization orientation; and
a second combination polarizing shutter element and pixel element, with said second polarizing shutter element being of a second polarization orientation that is substantially orthogonal to said first polarization orientation;
wherein said pixel unit is individually addressable and actuatable.

12. The apparatus of claim 10, wherein said shutter device comprises a microelectromechanical shutter element comprising a two-dimensional array of individually addressable shutter elements.

13. The apparatus of claim 10, further comprising a memory including an address storage capable of storing one or more shutter element addresses.

14. The apparatus of claim 10, further comprising a memory including a pattern storage capable of storing one or more shuttering patterns that specify a plurality of shutter addresses of shutter elements to be actuated.

15. The apparatus of claim 10, further comprising a memory including a pattern storage capable of storing one or more shuttering patterns that specify a plurality of exposure times corresponding to a plurality of shutter elements to be actuated.

16. A light shuttering method for a still image capturing device, comprising the steps of:
providing an electronic imaging sensor device comprising a plurality of pixel elements; and
providing an electronically actuated shutter device comprising a plurality of individually addressable and actuatable shutter elements, each shutter element substantially corresponding to at least one of said plurality of pixel elements.

17. The method of claim 16, wherein the providing said shutter device step comprises forming said shutter device on said imaging sensor device.

18. The method of claim 16, wherein the providing said shutter device step comprises providing a two-dimensional array of individually addressable shutter elements, wherein a pixel unit of said imaging sensor device is individually addressable, wherein a first shutter element of said pixel unit polarizes light according to a first polarization orientation and a second shutter element of said pixel unit polarizes light according to a second polarization orientation that is substantially orthogonal to said first polarization orientation, and wherein the method provides a substantially non-polarized light to said imaging sensor device.

19. The method of claim 16, further including a step of storing a shutter actuation pattern that specifies a plurality of shutter elements to be actuated during an image capture.

20. The method of claim 16, further including a step of storing a shutter actuation pattern that specifies a plurality of exposure time periods for a corresponding plurality of shutter elements.
